(19) United States
(12) Patent Application Publication
(10) Pub. No.: US 2026/0112695 A1
(43) Pub. Date: Apr. 23, 2026

(54) POLYMER ELECTROLYTES BASED ON PERFLUOROPOLYETHERS AND DIMETHYLSULFOXIDE

(71) Applicant: Research Foundation of the City University of New York, New York, NY (US)

(72) Inventor: Michele Vittadello, Titusville, NJ (US)

(21) Appl. No.: 19/363,212

(22) Filed: Oct. 20, 2025

Related U.S. Application Data
(60) Provisional application No. 63/709,143, filed on Oct. 18, 2024.

(51) Int. Cl. H01M 10/0565; H01M 10/0525; H01M 10/054

(52) U.S. Cl. CPC H01M 10/0565; H01M 10/0525; H01M 10/054; H01M 2300/0082

(57) ABSTRACT

A polymer electrolyte formed from the block copolymerization of a polyethylene glycol (PEG) and a perfluorinated polyether (PFPE). An electrolyte-plasticizer with bis(trifluoromethane)sulfonimide sodium salt NaTFSI and dimethylsulfoxide (DMSO) is present such that the polymer electrolyte is PEG-PFPE-PEG/(NaTFSI)ₓ (DMSO)_{y} (0.004≤x≤0.610, 3.205≤y≤3.794).

### CROSS-REFERENCE TO RELATED APPLICATIONS

This application claims priority to, and is a non-provisional of, U.S. Patent Application 63/709,143 (Oct. 18, 2024), the entirety of which is incorporated herein by reference.

### BACKGROUND OF THE INVENTION

Sodium is a viable alternative to lithium as a charge carrier in secondary batteries given its redox potential, −3.03 V vs SHE for Li and −2.71 V vs SHE for Na. There are plenty of sodium reserves, and sodium salts are generally available at low costs. For these reasons, sodium ion batteries (SIBs) have attracted more and more attention as a possible substitute for lithium ion batteries (LIBs).

Most commercially available LIBs rely on liquid electrolytes such as ethylene carbonate and propylene carbonate. Battery safety is highly improved when using Li-ion conducting polymer electrolytes (PEs) to assemble lithium polymer batteries (LPBs). Conventional or solvent-free PEs are comprised of a mixture of a suitable polymer host and a salt. Poly(ethylene oxide) (PEO) derivatives are the most studied polymer hosts. The resulting electrolytes are endowed with highly desirable properties making them ideal for use in rechargeable batteries, including sodium polymer batteries (SPBs), namely, no liquid leakage, minimal flammability, high processability in a variety of formats, and outstanding mechanical flexibility. When compared to liquid electrolytes and inorganic solid electrolytes, PEs usually ensure improved stabilization of the solid electrolyte interphase (SEI). The cationic transference number of PEO-based PEs is typically between 0.1 and 0.5.

Recently, the potential advantages of using perfluorinated polyethers (PFPEs) as alternatives to PEO or poly(ethylene glycol) (PEG) in the synthesis of polymer electrolytes have been proposed. Low molecular weight hydroxy-terminated PFPEs were used to dissolve bis(trifluoromethane)-sulfonimide lithium salt (LiTFSI). These systems are nonflammable and have a very high Li⁺ transference number (i.e., 0.91), high thermal stability (above 200° C.), and low glass transition temperatures (between −89° C. and −117° C.). These properties were further improved by converting the terminal OH groups into methylcarbonates. Blends of low molecular weight PEG (400 g/mol) and PFPE (700 g/mol) were investigated for the purpose of preparing PEs with LiTFSI. Full miscibility occurred only with a molar fraction of PEG above 0.6.

The promise of sodium-ion conducting polymer electrolytes in rechargeable power sources is yet to be fulfilled. A need for improved or alternative polymer electrolytes remains.

The discussion above is merely provided for general background information and is not intended to be used as an aid in determining the scope of the claimed subject matter.

### SUMMARY

This disclosure provides a polymer electrolyte formed from the block copolymerization of a polyethylene glycol (PEG) and a perfluorinated polyether (PFPE). An electrolyte-plasticizer with bis(trifluoromethane)sulfonimide sodium salt NaTFSI and dimethylsulfoxide (DMSO) is present such that the polymer electrolyte is PEG-PFPE-PEG/(NaTFSI)ₓ (DMSO)_{y} (0.004≤x≤0.610, 3.205≤y≤3.794). An advantage that may be realized in the practice of some disclosed embodiments of the polymer electrolyte is that a polymer electrolyte is provided that is electrically conductive.

In a first embodiment, a polymer electrolyte is provided. The polymer electrolyte comprising: a block polymer formed from the block copolymerization of a polyethylene glycol (PEG) and a perfluorinated polyether (PFPE); an electrolyte-plasticizer composition comprising (NaTFSI)ₓ(DMSO)_{y}, wherein DMSO is dimethylsulfoxide; NaTFSI is bis(trifluoromethane)sulfonimide sodium salt; x is mole percent of the NaTFSI relative to moles of the block polymer, 0.004≤x≤0.610; y is mole percent of the DMSO relative to moles of the block polymer, 3.205≤y≤3.794; wherein the block polymer is present in a mass percent of 70±10; the DMSO is present in a mass percent of 20±5; and the NaTFSI is present in a mass percent from 0.09-13%.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 are graphs depicting decomposition of region I of selected FT-IR spectra of the PEG-PFPE-PEG/(NaTFSI)ₓ (DMSO)_{y} (0.004≤x≤0.610, 3.205≤y≤3.794) polymer electrolytes.

FIG. 2 are graphs depicting decomposition of region II of selected FT-IR spectra of the PEG-PFPE-PEG/(NaTFSI)ₓ(DMSO)_{y} (0.004≤x≤0.610, 3.205≤y≤3.794) polymer electrolytes.

FIG. 3 is a graph showing the relationship between the percentage fractional area of the peak intensities of the FT-IR bands in region I and II of the PEGPFPE-PEG/(NaTFSI)ₓ(DMSO)_{y} (0.004≤x≤0.610, 3.205≤y≤3.794) polymer electrolytes, as a function of the molar ratio n_{Na}/n_{polym}.

FIG. 4 is a graph showing dependence of the direct current conductivity σ vs reciprocal temperature of the PEG-PFPE-PEG/(NaTFSI)ₓ(DMSO)_{y} (0.004≤x≤0.610, 3.205≤y≤3.794) polymer electrolytes. The dotted lines show the fitting of the curves by using the VTF equation.

FIG. 5 is a graph showing dependence of the equivalent conductivity A vs the square root of the molality c_{Na}^{1/2} of the PEG-PFPE-PEG/(NaTFSI)ₓ(DMSO)_{y} (0.004≤x≤0.610, 3.205≤y≤3.794) polymer electrolytes. The dotted lines show the fitting by using an exponential decay function added to two Gaussian functions (equation (2)).

FIG. 6 shows graphs illustrating dependence of the interdomain polarization conductivities σₙ (n=2, 3, 4) vs reciprocal temperature of the PEG-PFPE-PEG/(NaTFSI)ₓ(DMSO)_{y} (0.004≤x≤0.610, 3.205≤y≤3.794) polymer electrolytes. The dotted lines show the fitting of the curves by using the VTF equation (equation (1)).

FIG. 7 shows graphs illustrating dependence of the interdomain polarization frequencies fₙ (n=2, 3, 4) vs reciprocal temperature of the PEG-PFPE-PEG/(NaTFSI)ₓ(DMSO)_{y} (0.004≤x≤0.610, 3.205≤y≤3.794) polymer electrolytes. The dotted lines show the fitting of the curves by using one or two Arrhenius equations (equation (7)).

### DETAILED DESCRIPTION OF THE INVENTION

This disclosure provides a new polymer electrolyte family based on the PFPE polymer, DMSO as plasticizer, and NaTFSI as a dopant, with general formula PFPE-block-PEG/(NaTFSI)ₓ(DMSO)_{y} (0.004≤x≤0.610, 3.205≤y≤3.794). More specifically, this disclosure provides plasticized polymer electrolytes based on an α, ω-OH-terminated poly[PFPE-block-PEO](hereafter called PEG-PFPE-PEG), sodium bis(trifluoromethanesulfonyl)imide (NaTFSI), and dimethyl sulfoxide (DMSO) as plasticizer, having general formula PEG-PFPE-PEG/(NaTFSI)ₓ(DMSO)_{y} (0.004≤x≤0.610, 3.205≤y≤3.794). The introduction of DMSO was shown to be necessary for ionic mobilization. In the absence of DMSO, the conductivity of PEG-PFPE-PEG doped with NaTFSI was so low that it could not be measured.

The thermal analysis results, carried out by means of DSC, indicate that the plasticizer remains intimately integrated in the polymer electrolytes up to the decomposition temperature of PEG-PFPE-PEG (180° C. ca.) and is not significantly released out of the polymer hosts in closed cells.

The vibrational investigation, carried out by FT-IR spectroscopy in the medium IR region, shed light on NaTFSI-PEG-PFPE-PEG-DMSO interactions. In particular, the role of the OH functional groups in facilitating salt dissolution was elucidated, along with that of the CO and CF moieties.

The ionic conductivity was investigated by impedance spectroscopy, in the frequency interval 100 mHz to 1 MHz. The conductivity at 25° C. is as high as 8.0×10⁻⁴ S·cm⁻¹. Three of at least five polarization events (one electrode and four interdomain polarizations in total) were fully resolved and were associated with different interfacing domains in the polymer electrolytes with increasing DMSO content. Furthermore, it was shown that the presence of DMSO significantly decreases the glass transition temperature of the electrolytes.

In some embodiments, the DMSO is present in a mass percent of 20±5 or 20±2, relative to the total mass of the polymer electrolyte. In some embodiments, the block polymer (PEG-PFPE-PEG) is present in a mass percent of 70±10, 73±8 or 75±5 relative to the total mass of the polymer electrolyte. In some embodiments, the NaTFSI is present in a mass percent from 0.09-13%, 0.09-7%, from 0.09-2%, from 0.09-1% relative to the total mass of the polymer electrolyte.

Synthesis of PEG-PFPE-PEG/(NaTFSI)ₓ(DMSO)_{y} Polymer Electrolytes. A series of PEs with general formula PEG-PFPE-PEG/(NaTFSI)ₓ(DMSO)_{y} (0.004≤x≤0.610, 3.205≤y≤3.794) were prepared by mixing 7.0 g of PEG-PFPE-PEG with 0.010 to 1.296 g of NaTFSI and 2.075 g of DMSO, in 100 mL Pyrex bottles. The mixtures were stirred until complete dissolution of the salt (24 h); the resulting solutions were colorless and transparent. The PEG-PFPE-PEG/(NaTFSI)_{0.610}(DMSO)_{3.794} tends to become cloudy if left untouched for a few days, without showing precipitation. See Table 1 for the elemental composition of the PEs; the samples were labeled from S1 to S8, in order of decreasing salt concentration.

TABLE 1
Composition of the PEG-PFPE-PEG/(NaTFSI)ₓ(DMSO)_{y} (0.004 ≤ x ≤
0.610, 3.205 ≤ y ≤ 3.794) Polymer Electrolytes

| | | | | X = | X = |
|---|---|---|---|---|---|
| | | | | n_{Na}/ | n_{DMSO}/ |
| Sample | % PFPE^{b} | % NaTFSI^{a} | % DMOS^{b} | n_{polym}^{a, b} | n_{polym}^{a, b} |
| S1 | 67.52 | 12.47 | 20 | 0.61 | 3.794 |
| S2 | 73.75 | 6.25 | 20 | 0.279 | 3.472 |
| S3 | 76.88 | 3.12 | 20 | 0.134 | 3.331 |
| S4 | 78.44 | 1.56 | 20 | 0.064 | 3.265 |
| S5 | 79.22 | 0.77 | 20 | 0.032 | 3.233 |
| S6 | 79.61 | 0.39 | 20 | 0.016 | 3.217 |
| S7 | 79.81 | 0.19 | 20 | 0.008 | 3.209 |
| S8 | 79.91 | 0.09 | 20 | 0.004 | 3.205 |

^{a}% NaTFSI and n_{Na} are the mass percentage of NaTFSI and the number of moles of Na, respectively, within PEG-PFPE-PEG/(NaTFSI)ₓ(DMSO)_{y} (0.004 ≤ x ≤ 0.610, 3.205 ≤ y ≤ 3.794) polymer electrolytes, determined by ICP-AES analysis of Na with respect to total mass.
^{b}% DMSO, % PFPE and n_{DMSO}, n_{polym} are the mass percentages and number of moles of DMSO and PEG-PFPE-PEG, respectively, determined from the measured experimental masses of DMSO and PEG-PFPE-PEG.

PEO and PEG are typical polymer hosts in the synthesis of PEs. PFPEs represent intriguing homologues to PEO-based polymers. The complete or partial substitution of fluorine atoms for hydrogen atoms in a polyalkylene chain is likely to have major effects on polymer-polymer and polymer-salt interactions. Fluorine is the most electronegative element (ϵ=4.0) of the periodic table and is more electronegative than hydrogen (ϵ=2.1). The general structure of the PEG-PFPE-PEG (FLUOROLINK E10-H®) is shown below.

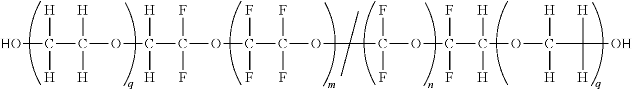

wherein q, m, and n are selected to provide an average molecular weight within 10% of Mₙ=1000. In one embodiment, q is 2, m is 4.65 and n=1.61, on average.

The numerical molecular weight, Mₙ in g/mol varies between 800 g/mol and 1100 g/mol. Mₙ was treated to be ˜1000 g/mol. The expected structure of PEG-PFPE-PEG was confirmed by ¹H and ¹³C NMR spectra. Based on a ¹⁹F NMR spectrum of PEG-PFPE-PEG the experimental m/n ratio is equal to 2.91. Under the assumption that q=2, it was calculated that m=4.65 and n=1.61. The ratio of the latter two parameters

$$( \frac{m}{n} = 2.89 )$$

is sufficiently close to the experimental ratio derived from NMR.

DMSO is a good solvent for PEG-PFPE-PEG based on known values of the Hansen parameter δ. The expected δ value for PEG-PFPE-PEG is likely to fall within the interval 23.2<δ<47.8, between the value for PVDF and that for water. Therefore, DMSO (δ=26.7) is believed to provide a better match for PEG-PFPE-PEG than triethylphosphate (TEP) (δ=22.3). The comparison of the dipole moments of DMSO (μ=3.96 D) and of TEP (μ=2.86 D) suggest that DMSO is more apt at promoting salt dissociation than TEP. DMSO is a better solvent for the polymer host but also facilitates a higher dissolution of the salt than TEP.

The synthesis of the PEG-PFPE-PEG/(NaTFSI)ₓ(DMSO)_{y} (0.004≤x≤0.610, 3.205≤y≤3.794) PEs was carried out by direct dissolution of NaTFSI in the polymer host in the presence of 20% m/m DMSO as plasticizer (see Table 1). The samples were colorless and transparent viscous liquids, regardless of the concentration of salt. A slight increase in viscosity was observed at higher levels of doping. LiTFSI was shown to dissolve directly in high weight percentages. This is consistent with Li⁺ having a higher charge density than Na⁺. This difference accounts for Li⁺ salts being easily dissolved in both polar and nonpolar solvents. PEG-PFPE-PEG per se does dissolve NaTFSI, but the introduction of DMSO was shown to be necessary for ionic mobilization. The anion TFSI⁻ exhibits high delocalization of the electronic charge and therefore facilitates the ionic dissociation of LiTFSI. At the same time, the anion interacts preferentially with the fluorine atoms of the polymer host. The same anionic behavior is likely to occur with NaTFSI.

### Thermal Analysis

Thermal Analysis of PEG-PFPE-PEG/(NaTFSI)ₓ(DMSO)_{y} Polymer Electrolytes: The DSC profiles of the PEs are shown in provisional patent application 63/709,143. The interpretation of the thermal profiles is simplified by the comparison with the differential thermogravimetric profile of a selected PE. Minor evaporation of DMSO in different measures is observed in the DSC profiles as endothermic events below 130° C., depending on the specific samples. Complete loss of DMSO does not occur from a sample in a hermetically closed pan (DSC), as opposed to an open pan (DTG). On the basis of the comparison between the approximated enthalpy of vaporization of DMSO from the samples and the reported value of the enthalpy of vaporization for pure DMSO, only 0.5 to 1.2% of DMSO evaporated from the samples below 130° C. The DSC profiles reveal endothermic events occurring between 183 and 196° C. These events are attributed to the decomposition of PEG-PFPE-PEG within the PEs and additional evaporation of DMSO. Even assuming that the latter endothermic peak is due completely to DMSO evaporation, at most only 1.0 to 2.3% of DMSO would have evaporated from the entire samples in this temperature range. This observation still confirms that the loss of DMSO is minimal. Further confirmation of this point comes from the conductivity measurements. Exothermic events immediately followed by endothermic events are observed between 27° and 380° C. These events are attributed to the exothermic decomposition of DMSO and NaTFSI, followed by the endothermic formation of sodium carbonates and oxides. These assignments are compatible with the fact that the exothermic decomposition of pure DMSO is known to occur at 278° C. Also, the exothermic decomposition of pure LiTFSI was previously measured at 340° C. A relatively stable solid residue is indeed observed above 380° C. Therefore, PEs are safe to use below ca. 180° C.

### Infrared Analysis

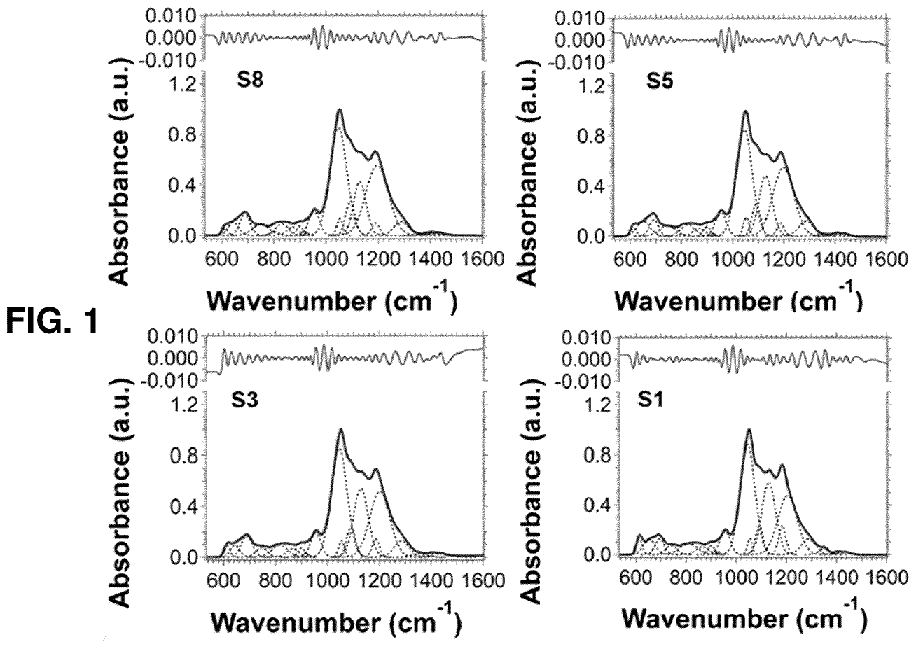

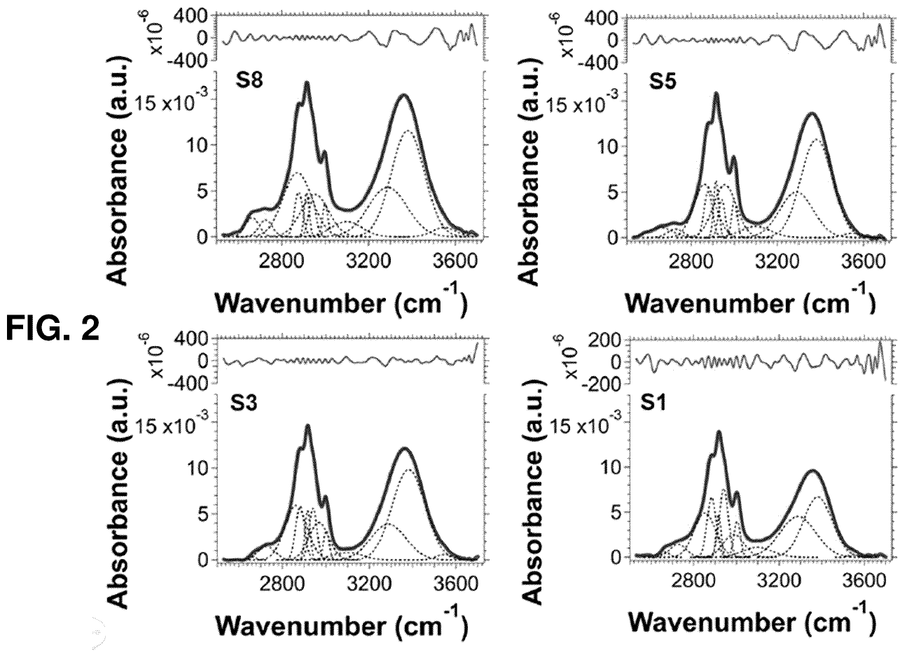

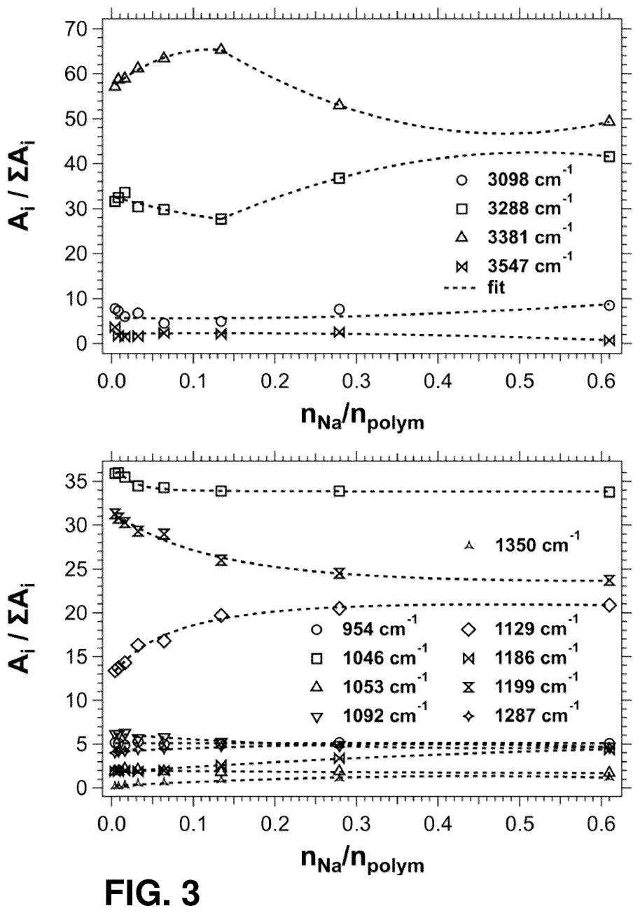

Fourier Transformed Infrared Spectroscopy of PEG-PFPE-PEG/(NaTFSI)ₓ(DMSO)_{y} Polymer Electrolytes: The FT-IR spectra of the PEs in the mid-infrared region, between 535 and 4000 cm₋₁, are shown in provisional patent application 63/709,143. The spectrum of PEG-PFPE-PEG is also given for comparison. Normalization of the profiles was performed with respect to the highest peak on the envelope, which was observed at 1055 cm⁻¹. The spectrum of PEG-PFPE-PEG departs slightly from those of the PEs in the fingerprint region. The spectral features at high frequencies are dwarfed by the fingerprint absorbances but could still be resolved. The spectral decomposition by means of Gaussian peaks of the PEs and the polymer host was performed in the regions 535 and 1600 cm⁻¹ and 2600 and 3680 cm⁻¹, identified as region I (FIG. 1) and region II (FIG. 2), respectively. Selected decomposed spectra of the PEs in both regions are shown in FIG. 1 and FIG. 2. Decomposition in region I of the PEs presents more important differences only for eight peaks identified between 930 and 1380 cm⁻¹. Similarly, the most meaningful changes in region II are observed for four peaks detected between 3050 and 3600 cm⁻¹. In both cases, the discrepancies are found mainly for the areal contribution of the peaks and not as much in terms of frequency deviations. The percentage contribution of the peaks in these spectral portions, with respect to the sum of the areas, is given as a function of the molar ratio n_{NA}/n_{polym}(x), in FIG. 3. In this ratio, “polym” stands for PEG-PFPE-PEG, for brevity. The ATR spectra were processed without ATR correction, in spite of low intensity at higher frequencies, because no anomalous dispersion was observed, and the spectral features were sufficiently well-defined.

TABLE 2
FT-IR Band Assignments for the PEG-PFPE-PEG/(NaTFSI)x(DMSO)y
(0.004 ≤ x ≤ 0.610, 3.205 ≤ y ≤ 3.794 Polymer Electrolytes.

Observed wavenumbers (cm⁻¹)

| PEG-PFPE- | PEG-PFPE- | |
|---|---|---|
| PEG^{a,b} | PEG/(NaTFSI)ₓ(DMSO)_{y}^{a,b} | Assignment |
| | 3547 (vvw) | ${v}_{free}^{PEG} ( OH )$ |
| 3480 (vw) | | ${v}_{a}^{PEG} ( OH )$ |
| 3370 (vw) | 3381 (vw) | ${v}_{s}^{PEG} ( OH )$ |
| 3194 (vw) | 3288 (vw) | ${v}_{Hy}^{PEG} ( OH )$ |
| | 3098 (vvw) | ${v}_{DMSO}^{PEG} ( OH )$ |
| | 3003 (vw) | ${v}_{a}^{DMSO} ( {CH}_{3} ) , {v}_{a}^{{DMSO}^{′}} ( {CH}_{3} ) ( {A}^{′} , {A}^{″} )$ |
| 2956 (vw, sh) 2941 (vw) | $\begin{matrix}2986 ( vw , sh ) \\ 2940 ( vw )\end{matrix} \}$ | ${v}_{a}^{PEG} ( {CH}_{2} )$ |
| | 2916 (vw) | ${v}_{a}^{DMSO} ( {CH}_{3} ) ( {A}^{′} )$ |
| 2882 (vw) 2852 (vw, sh) | $\begin{matrix}2883 ( vw ) \\ 2852 ( vw , sh )\end{matrix} \}$ | ${v}_{s}^{PEG} ( {CH}_{2} )$ |
| 2720 (vvw, sh) | 2726 (vvw, sh) | ${v}_{a}^{PEG} ( HO - \underline{{CH}_{2}} )$ |
| 2658 (vvw, sh) | 2666 (vw, sh) | ${v}_{s}^{PEG} ( HO - \underline{{CH}_{2}} )$ |
| 1428 (vw) | 1431 (vw) | ${{δ}_{sr}^{PFPE} ( {CF}_{2} )}^{*} , {δ}_{sr}^{PEG} ( {CH}_{2} )$ |
| 1401 (vw) | 1400 (vw) | ω^{PFPE}(CF₂)*, ω^{PEG}(CH₂) |
| 1350 (w, sh) | 1350 (w, sh) | ${{v}_{a}^{NaTFSI} ( {SO}_{2} )}^{*} , {ω}^{PEG} ( {CH}_{2} )$ |
| 1286 (w, sh) | 1287 (w, sh) | τ^{PEG}(CH₂) |
| 1188 (w) 1180 (s) | $\begin{matrix}1199 ( s ) \\ \end{matrix} \}$ | $\{ \begin{matrix}{{v}^{polym} ( CO )}^{*} , {{v}^{PFPE} ( CF )}^{*} , \\ or \\ {{v}^{polym} ( \underline{CO} ⋯ {Na}^{+} )}^{*} , \\ {v}^{PFPE} ( \underline{CF} ⋯ {TFSI}^{-} )\end{matrix}$ |
| | 1186 (w) | ${v}_{a}^{NaTFSI} ( {SO}_{2} ) , {v}_{a}^{NaTFSI} ( {CF}_{3} )$ |
| 1123 (m) | 1129 (m) | $\{ \begin{matrix}{{{v}^{polym} ( CO )}^{′}}^{*} , {{{v}^{PFPE} ( CF )}^{′}}^{*} , \\ or \\ {{{v}^{polym} ( \underline{CO} ⋯ HO - )}^{′}}^{*} , \\ {{{v}^{PFPE} ( CF )}^{′}}^{*}\end{matrix}$ |
| | 1092 (w) | v^{DMSO}(SO), ρ^{DMSO}(CH₃) (A′) |
| 1096 (w) | 1053 (w) | v^{PEG}(CO), ρ^{PEG}(CH₂), v^{PEG}(CC), |
| | | v^{PFPE}(CF)* |
| 1056 (vs) | 1046 (vs) | v^{PFPE}(CF) |
| 967 (w) 928 (vvw, sh) 913 (vw, sh) | $\begin{matrix}954 ( w ) \\ 927 ( vvw , sh ) \\ 915 ( vvw , sh )\end{matrix} \}$ | ρ^{PEG}(CH₂), v^{polym}(CC)*, v^{polym}(CO)*, ρ^{PFPE}(CF₂)* |
| 895 (w) 865 (w, sh) 832 (w) 804 (vw, sh) | $\begin{matrix}899 ( w ) \\ 865 ( w , sh ) \\ 810 ( w ) \\ 790 ( vvw , sh )\end{matrix} \}$ | ρ^{polym}(CH₂)*, v^{polym}(CO)*, ρ^{PFPE}(CF₂)* |
| 746 (w) 637 (w) | $\begin{matrix}741 ( w ) \\ 695 ( w ) \\ 654 ( w )\end{matrix} \}$ | $\{ \begin{matrix}{{δ}^{polym} ( CCO )}^{*} , \\ {{δ}^{polym} ( COC )}^{*} , \\ {{ρ}^{polym} ( {CH}_{2} )}^{*} , \\ {{ρ}^{PFPE} ( {CF}_{2} )}^{*}\end{matrix}$ |
| 610 (w, sh) | 613 (w, sh) | v^{NαTFSI}(CF₃) |

^{a}Relative intensities of observed bands are reported in parentheses: vs, very strong; s, strong; m, medium; w, weak; vw, very weak; sh, shoulder.
^{b}v, stretching; δ, bending; ρ, rocking; ω, wagging; τ, twisting; δₛᵣ scissoring; a, antisymmetric; s, symmetric.
^{c}Free, isolated OH group; polym, PEGPFPE-PEG; Hy, hydrogen bonding cage of OH groups with TFSI⁻.

Without wishing to be bound to any particular theory, the dissolution of DMSO in high amounts is believed to introduces a stronger competitor for hydrogen bonding with the OH groups [—OH···OS(CH₃)]. Given the dipole moment of the O—H bond (μ=1.5 D), two or three OH groups [—OH···ₙ(CH—)] are probably needed to match one DMSO molecule (μ=3.69 D). Two or more DMSO molecules may coordinate the same OH group, due to their tendency to aggregate with each other [—OH···ₘ(OS(CH₃))]. When the salt NaTFSI is mixed in, each DMSO molecule can coordinate the cation through O and weakly coordinate the anion via the C—H bonds [Na⁺·OS(CH₃)···TFSI−]. This pattern is further complicated by the OH functional groups which can simultaneously coordinate the anion (—OH···TFSI⁻) or DMSO [—OH···OS(CH₃)]. Additionally, DMSO is expected to interact with the CO moieties of the polymer backbone, more with those of PEG than those of PFPE.

If NaTFSI is dissolved in PEG-PFPE-PEG in the absence of DMSO, the cation Na⁺ is expected at first to be preferentially coordinated by the PEG moieties of the polymer, while the anion TFSI⁻ is coordinated by the F atoms of the PFPE unit. This behavior should occur in analogy to what has been established by WAXS measurement of LiTFSI in the same polymer host. Na⁺ is likely to be delocalized among the oxygens of the PEG oligomers. As the salt concentration increases, NaTFSI is predicted to be coordinated by PFPE as well, mainly by CF₂···TFSI⁻ interactions. If DMSO is present, this compound dominates the interactions with the salt, in competition with the OH, CO, and CF moieties of the polymer host.

The peak at 3547 cm⁻¹ was attributed to the stretching OH of isolated or “free” OH groups

$$[ ( {v}_{free}^{PEG} ( OH ) ] .$$

The wavenumber value is a bit lower than the previous reported values, because of the indirect influence of DMSO. The peak is absent in the pristine polymer host and this finding suggests the role of DMSO in causing a small degree of terminal OH isolation, through the formation of aggregate subdomains. These isolated OH groups are likely to be involved in intramolecular binding with PEG-PFPE-PEG. The peak at 3381 cm⁻¹ is assigned to the symmetric stretching vs PEG(OH), specifically pertinent to the PEG units. The same band is visible for PEG-PFPE-PEG at 3370 cm⁻¹, but no antisymmetric stretching is observed. The peak at 3288 cm⁻¹ is assigned to OH groups involved in hydrogen bonding cages with the anion TFSI⁻ and

$$DMSO [ {v}_{Hy}^{PEG} ( OH ) ] ,$$

while the peak at 3098 cm⁻¹ is assigned to OH groups interacting exclusively with

$$DMSO [ {v}_{DMSO}^{PEG} ( OH ) ] .$$

In the case of PEG400/(LiCl)ₓ, hydrogen bonding cages with chloride anions were measured at 3191 cm⁻¹. The presence of DMSO has the effect of decreasing the effective charge of the anion (—OH···TFSI⁻···DMSO), thereby shifting the corresponding OH band to lower energy than previously observed.

As seen in FIG. 3, the percentage fractional area of the peaks at 3547 and 3098 cm⁻¹ do not appreciably change with x, thus indicating that these OH groups are not affected by the salt. In the interval 0.004≤x≤0.134, the percentage fractional areas of the peaks at 3288 and 3381 cm⁻¹ decrease and increase, respectively. As the concentration of salt increases, NaTFSI interacts preferentially with the abundant DMSO and not as much with the OH groups. At the same time, some Na⁺ will be coordinated by CO moieties of PEG and will subtract electronic density from the terminal OH groups, causing a decrease in intensity. This decrease in intensity may be further enhanced if the OH groups are coordinated by DMSO as well. The Na⁺-coordination number is expected to be at least four, as in the case of Li⁺, Mg²⁺, and Eu³⁺. Na⁺ has a bigger ionic radius (116 pm) than these ions, which are similar in size (˜90 pm). So, from a geometrical standpoint, the coordination number can be greater than 4. At the same time, the coordination number of Na⁺ in Na₂O is still 4. So, two in-chain oxygen atoms from PEG may be complemented by two DMSO molecules in the first coordination sphere of the cation. At the same time, the anion TFSI⁻ is preferentially interacting with fluorine atoms located on PFPE. Therefore, at low salt concentration, the contribution of

$${v}_{DMSO}^{PEG}$$

(OH) decreases, while the contribution of

$${v}_{s}^{PEG} ( OH )$$

increases. The opposite happens for 0.134≤x≤0.610, where the percentage fractional area for

$${v}_{Hy}^{PEG} ( OH )$$

increases while that of

$${v}_{s}^{PEG} ( OH )$$

decreases. This observation can be explained knowing that, as the salt concentration increases TFSI⁻ can interact with OH groups otherwise involved in hydrogen bonding among themselves, with or without the assistance of DMSO.

The discussion about the stretching OH bands in region II can be extended to the stretching CO and CF bands in region I. The peaks at 1129 cm⁻¹ and at 1199 cm⁻¹ present opposite behavior: the former increases with x, while the latter decreases. These peaks are assigned to ν^{polym}(CO···HO—), ν^{PEPE}(CF)′, ν^{polym}(CO···Na⁺), ν^{PEPE}(CF···TSFI⁻), respectively. The same peaks, without the ionic interactions, can be found in the polymer host. The first peak corresponds to the stretching of the CO groups of PEG and PFPE units involved in hydrogen bonding with OH groups. When the cations become available, these interactions give way to a more favorable ion-dipole interaction, as reflected by the second peak. The first peak includes the stretching of the CF groups of PFPE. These groups can favorably interact with the anion at the expense of interchain London dispersion forces between chains, as revealed by the second peak. The assignment of these peaks is corroborated by comparison with the CO groups measured in PEG400/(LiCl)ₓ at 1078 cm⁻¹ and at 1123 cm⁻¹. The overall decrease of the former peak as opposed to the latter, in terms of fractional area, was accompanied by an increase in wavenumber for both peaks (more pronounced for the latter). The peaks in the disclosed materials have systematically higher wavenumber values and this observation is consistent with the fact that the polymer is PEG-PFPE-PEG and not just PEG. The first peak in PEG-PFPE-PEG shifts in wavenumber from 1123 to 1129 cm⁻¹ in the PEs. The second peak at 1180 cm⁻¹, with a weak companion at 1188 cm⁻¹, shifts in frequency to an average of 1199 cm⁻¹ in the PEs. More in detail, the variation within the PEs is from 1128 to 1129 cm⁻¹ and from 1195 to 1204 cm⁻¹, respectively. Therefore, the analogy of the PEs with PEG400/(LiCl)ₓ, is maintained throughout.

The introduction of DMSO causes changes in region I with respect to pristine PEG-PFPE-PEG. A new peak is detected at 1092 cm⁻¹ which is attributed to the stretching SO and rocking CH₃ [ν(SO),ρ(CH₃)]. The same peak is absent from PEG-PFPE-PEG and does not change with x, as expected. The peak at 1350 cm⁻¹ quickly decreases to a plateau with increasing salt concentration. This peak is attributed to the antisymmetric stretching of the SO₂ units from NaTFSI and overlaps with the wagging of the PEG unit

$$[ {v}_{a}^{NaTFSI} ( {SO}_{2} ) , {ω}^{PEG} ( {CH}_{2} ) ] .$$

The small decrease in intensity is understood as signifying successful salt dissociation. The peaks at 1186 and 1287 cm⁻¹ were attributed to

$${v}_{s}^{NaTFSI} ( {SO}_{2} )$$

in conjunction with ν^{NaTFSI}(CF₃) and τ^{PEG}(CH₂), respectively. Both these bands increase linearly with x. As the salt concentration becomes higher, the intensity of the twisting bands of the CH₂ groups increases, with the same slope as the aforementioned band due to the dopant. This phenomenon is due to ion pairing occurring within the PEG moieties (PEG···Na⁺···TFSI⁻). The pairing diminishes the electronic withdrawal from the CH₂ groups caused by the cationic O-coordination resulting in a positive change of intensity of τ^{PEG}(CH₂). The remaining vibrational bands tend to plateau and are only mildly affected by the increasing salt concentration.

### Electrochemical Analysis

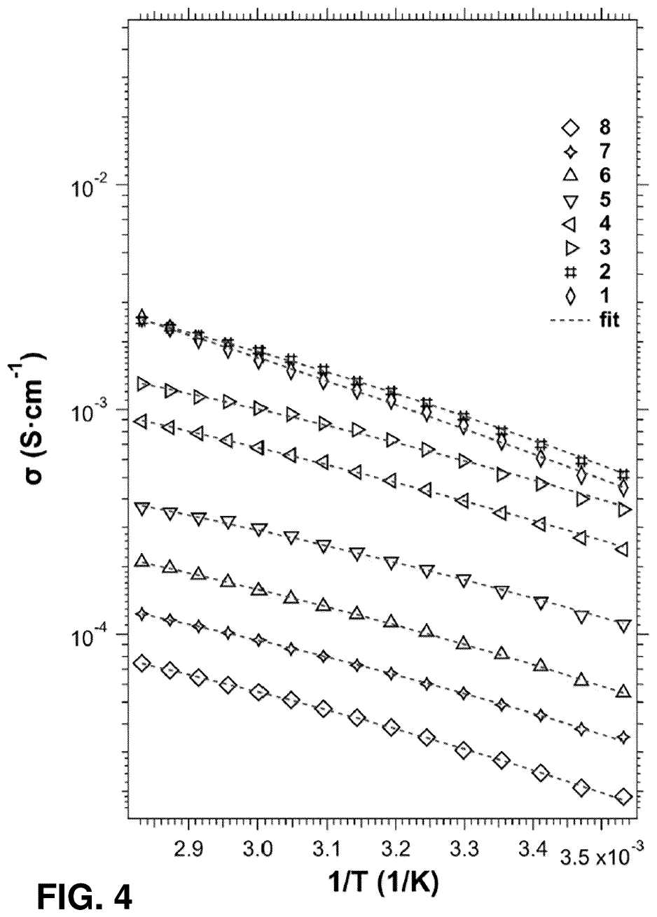

Electrical Spectroscopy Analysis of PEG-PFPE-PEG/(NaTFSI)ₓ(DMSO)_{y} Polymer Electrolytes: Impedance or electrical spectroscopy measurement in the range 100 mHz to 1 MHz were performed using Pt blocking electrodes on the plasticized PEs. The results were diagrammed in the form of Nyquist plots (—Z″(ω) vs Z′(ω)) and fitted with the equivalent circuit provided. The equivalent circuit can be written in brief as Q₁+R₂/Q₂+R₃/Q₃. Q₁ is a constant phase element with the character of a capacitor, so it can be attributed to the electrical double layer. R₂/Q₂ and R₃/Q₃ can be ascribed to RC circuits describing the salt-doped polymer phase and DMSO phase, respectively. R₃ was greater than R₂. The fitting satisfactorily allowed extraction of the values of the bulk resistance for the polymer phase, from which the direct current conductivity σ was calculated. The graph of σ vs reciprocal temperature is shown in FIG. 4. The conductivity profiles were fitted by means of a single-region Vogel-Tamman-Fulcher equation, the so-called VTF equation:

$${σ}_{VTF} = \frac{{A}_{σ}}{\sqrt{T}} exp ( \frac{- {E}_{a , σ}}{R ( T - {T}_{o , σ} )} ) \qquad ( 1 )$$

where A_{σ} is a constant proportional to the concentration of ionic charge carriers, E_{a,σ} is a constant proportional to the activation energy for the conduction process, and T is the thermodynamic ideal glass transition temperature. T_{0,σ} is the temperature at which the configurational entropy becomes zero or the “free volume” vanishes. The boundary condition adopted in selecting the initial value for T0 is the following: (T_{g,σ}−55)≤T_{0,σ}≤(T_{g,σ}−40). The detection of VTF profiles indicates that the conduction environment is viscous and underlines the role of micro-Brownian motions in assisting the conductivity process. Such motions are attributed to the segmental motions of the polymer host and the tumbling of DMSO molecules. The conductivity at 25° C. is 8.0×10⁻⁴ S·cm⁻¹ for sample S2 and 7.2×10⁻⁴ S·cm⁻¹ for sample S1. The conductivity profiles are not affected by a significant mass loss of DMSO, even if the measurements were carried out in a conductivity cell with enough empty volume for DMSO to escape as a liquid or a gas. This observation confirms that the low vapor pressure of DMSO, aided by the interactions of DMSO with the host polymer and the salt, prevents an appreciable mass loss of DMSO, as inferred on the basis of the DSC measurements. In the absence of DMSO, the conductivity of PEG-PFPE-PEG doped with NaTFSI was so low that it could not be measured. Therefore, loss of DMSO from the PEs would have been associated with a marked drop in conductivity, which was not observed.

The concentration of the charge carriers, signified by A_{σ}, increases with the salt concentration, as expected. The ideal glass transition temperature T_{0,σ} decreases at first exponentially for 0.004≤x≤0.134, then increases to a maximum in the interval 0.134≤x≤0.279, finally goes lower for x=0.610. An overall decrease of T_{0,σ} with increasing salt concentration is quite normal. At the same time, the lower value in the range of variation of T_{0,σ} (60-137 K), is remarkably low. This observation can be explained in terms of the low glass transition temperature of PEG-PFPE-PEG, previously measured at −89° C. This pinpoints the expected value of T_{0,σ} for the pure polymer in the interval 129-144 K. A T_{0,σ} value as low as 60 K can be explained by recalling the influence of DMSO as a cryodepressant. The fact that DMSO is also a good solvent for the polymer host and salts can account for a limited reticulation in the electrolytic matrix, causing a further decrease of the glass transition temperature. This result points to using DMSO as plasticizer, to augment the low-temperature performance of power sources based on PFPE-containing electrolytes. Independent DSC measurements under cryostatic conditions would be needed for further validation of this result. The pseudoactivation energy E_{a,σ} is nearly flat, except for the highest value of x, and changes between 5 and 14 kJ/mol. It was previously seen that the activation energy in PEG-PFPE-PEG/(LiTFSI)x was roughly constant at all salt concentrations (Proceeding of the National Academy of Sciences 2014, 111, 3327-3331). It appears that DMSO is responsible for an upward E_{a,σ} breakout in the disclosed electrolytic systems at the highest salt concentration. In the absence of DMSO, the conductivity was impossible to measure directly with an impedance spectroscopy instrument. Therefore, DMSO is highly desirable for enabling ionic conductivity in the disclosed electrolytes.

### Further Analysis

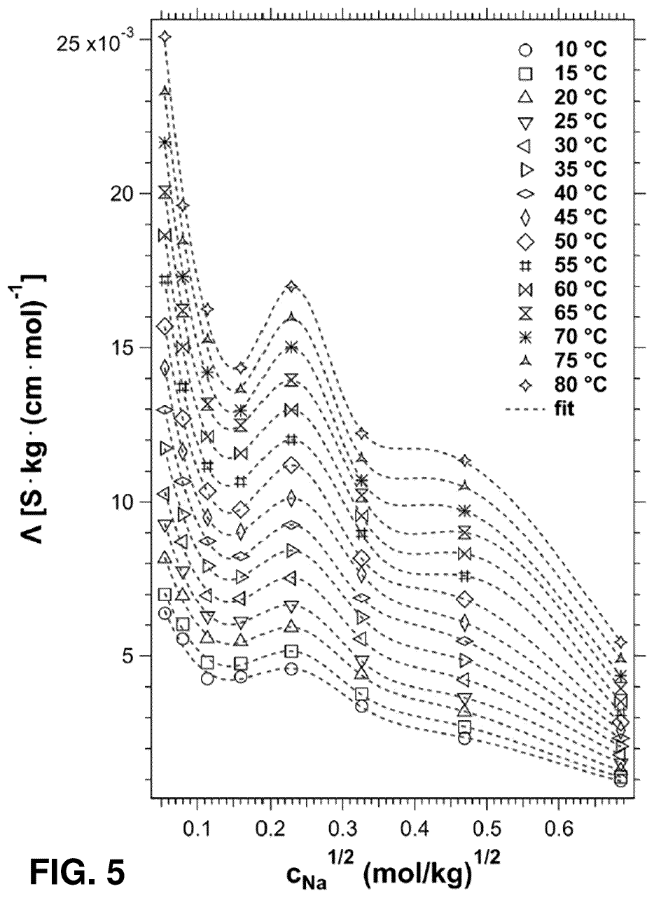

Deeper insight about ionic speciation in the PEs was obtained from the investigation of the equivalent conductivity Λ, as shown in FIG. 5. The profiles of Λ vs c_{Na}^{1/2} can be fitted by using the following equation:

$$Λ = {H}_{0} + {K}_{1} {e}^{- {α}_{1} {c}_{Na}^{1 / 2}} + {K}_{2} {e}^{- {{α}_{3} ( {c}_{Na}^{\frac{1}{2}} - {x}_{2} )}^{2}} + {K}_{3} {e}^{- {{α}_{3} ( {c}_{Na}^{1 / 2} - {x}_{3} )}^{2}} \qquad ( 2 )$$

The exponential decay of A with increasing c_{Na}^{1/2} is due to ion pairing of Na⁺ cations and anions TFSI− in the PEs. The subsequent formation of triple ions TFSI⁻···Na⁺···TFSI⁻ and Na⁺···TFSI⁻···Na⁺ in polymer-rich domains is detected as a peak centered at c_{Na}^{1/2}=0.23 (mol/kg)^{1/2}. The profile of Λ, up to this point, is similar to what was previously observed with PEG400/(LiCl)ₓ. An unusual second peak is measured at c_{Na}^{1/2}=0.39 (mol/kg)^{1/2}. This peak is attributed to the formation of similar triple ions in DMSO-rich domains.

Equation 2 reduces to the Onsager equation in the limit of zero concentration, under the conditions that Λ₀=H₀+K₁+K₂+K₃ and Λ=K₁α₁+2K₂α₂+2K₃α₃:

$$Λ = {Λ}_{0} - A \cdot {{c}_{Na}^{1 / 2}}_{} \qquad ( 3 )$$

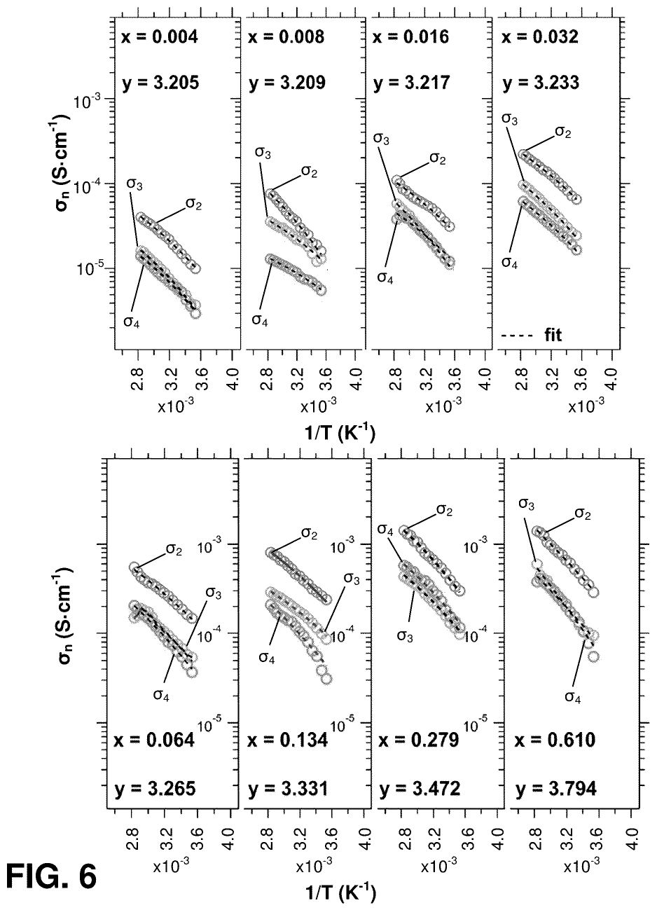

The Onsager parameters derived from the analysis of Λ, namely, A₀ and A are plotted against the reciprocal temperature in FIG. 6. There appear to be two regions in the graph, which are slightly shifted with respect to each other. These profiles can be fitted with a VTF-type equation as follows:

$${Λ}_{0}^{i} ( T ) = \frac{{Λ}_{0 , 0}^{i}}{\sqrt{T}} exp ( \frac{- {E}_{a , Λ}^{i}}{R ( T - {T}_{0 , Λ}^{i} )} ) \qquad ( 4 )$$

where

$${Λ}_{0 , 0}^{i}$$

is a pre-exponential constant,

$${E}_{a , Λ}^{i}$$

is the pseudoactivation energy for conduction at infinite dilution, and

$${T}_{0 , Λ}^{i}$$

is the thermodynamic ideal glass transition temperature for conduction at infinite dilution, with the index i identifying the fitting region (i=I, II). The same equation can be applied to the Onsager parameters Aⁱ. Two regions in the reciprocal temperature plot of the Onsager parameters is unusual. Inspection of the values of the VTF parameters

$${∧}_{0 , 0}^{i} , {E}_{a , ∧}^{i} and {T}_{0 , ∧}^{i} ,$$

for

$${∧}_{0}^{i} and {A}^{i}$$

seem to indicate that (a) the pre-exponential constants

$${∧}_{0 , 0}^{i}$$

are systematically much higher for Aⁱ than for

$${∧}_{0}^{i} ,$$

(b) the pseudoactivation energies

$${E}_{a , ∧}^{i}$$

are similar and close to the prevalent energy level measured for E_{a,σ} (5 kJ/mol), and (c) the ideal glass transition temperatures are different for

$${∧}_{0}^{i} and {A}^{i} ,$$

with

$${T}_{0 , ∧}^{II}$$

being 77 K higher than the highest value measured for

$${T}_{0 , σ}^{i}$$

(137 K). The VTF dependence confirms the importance of micro-Brownian motions in facilitating the conduction process, as either segmental motion of the polymer host or random movement of the DMSO molecules.

The impedance data were represented as real and imaginary relative permittivity [ε′(ω), ε″(ω)] and real and imaginary conductivity [σ′(ω), σ″(ω)] vs frequency. The spectra were analyzed and fitted in terms of the following general equation:

$${ε}^{*} ( ω ) = - {i ( \frac{{σ}_{o} ( T )}{{ε}_{0} ω} )}^{N ( T )} + {ε}_{∞} + {\sum }_{k} \frac{{Δε}_{k}}{{[ 1 + {( i {ωτ}_{k} )}^{{α}_{k}} ]}^{{β}_{k}}} + {\sum }_{n} \frac{{σ}_{el , n}}{i {ωε}_{0}} \frac{{( i {ωτ}_{n} )}^{{γ}_{n}}}{1 + {( i {ωτ}_{n} )}^{{γ}_{n}}} \qquad ( 5 )$$

where σ₀(T) is the conductivity at zero frequency, N(T) is a numerical exponent close to 1 for most materials, and ε_{∞} is the permittivity of the sample at infinite frequency and is related to the electronic contribution. The third and fourth terms in equation (5) describe the dielectric relaxations of the electrode and the interdomain polarization phenomena, respectively. Δε_{∞} is the relaxation strength, αₖ and βₖ are the symmetric and asymmetric shape parameters describing the broadening of the kth relaxation peak,

$${τ}_{k} = \frac{1}{2 π {f}_{k}}$$

is the dielectric relaxation time (with fₖ in Hz being the frequency of the peak position), and σ_{el,n} is the conductivity corresponding to the relaxation τₙ, the relaxation time associated with the electrode and interdomain polarization phenomena. Equation (5) can be used to derive a similar expression for σ*(ω).

The simulation of the permittivity and conductivity spectra was effectively carried out with equation (5), where only the last summation is not equal to zero. The first term is zero because it occurs below the low-frequency limit of the measurements; ε_{∞} is confirmed to be zero by the fitting itself, as it should be for a material that is not an electron conductor. The third term is zero because dielectric relaxation events take place well beyond the high-frequency limit of the measurements. The challenge in performing the fitting entails a refinement process that concludes only when the same set of parameters (for a given sample at a certain temperature) enables the simulation of all four permittivity and conductivity profiles. One representation is preferable to another for the purpose of honing in on a particular parameter. Five polarization events (n=1, . . . , 5) were identified in order of increasing frequency for all samples. The first four events were identified as interdomain polarization phenomena, while the last event was classified as an electrode polarization phenomenon. Each interdomain polarization phenomenon is due to the accumulation of charge at the interface of neighboring nanodomains having different permittivity in the bulk of the electrolyte. The electrode polarization phenomenon is due to the accumulation of charge at the interface of the Pt electrode and each sample. The first and the last events were partially detected in the fitting process.

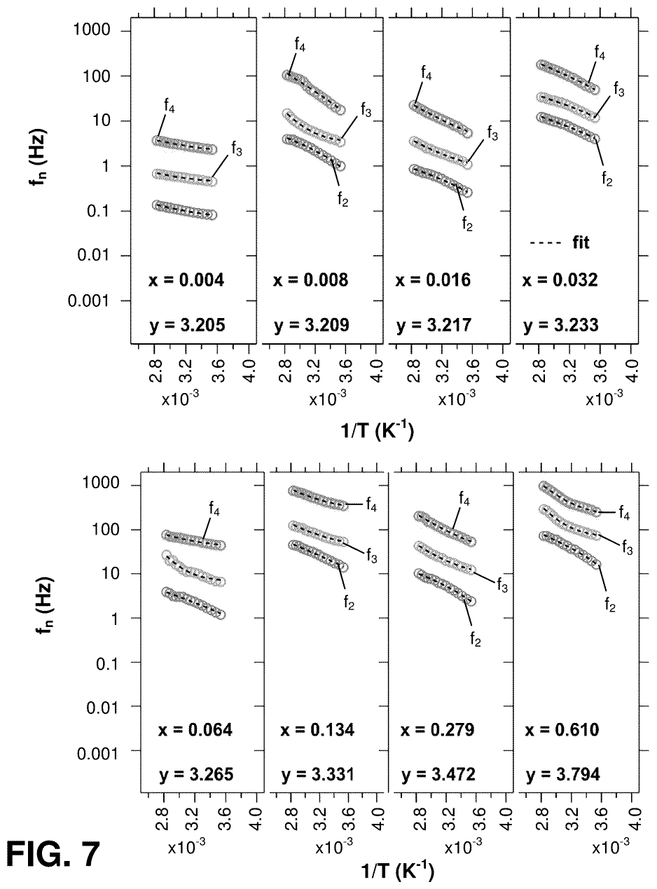

The inclusion of these lateral terms is necessary to be able to carry out the fitting successfully. Partial information can be derived about these events, but only the central three events could be resolved completely. The plots of the interdomain polarization conductivities e_{el,n}, or more simply σₙ (n=2, 3, 4), and interdomain polarization frequencies fₙ as a function of the reciprocal temperature are shown in FIG. 6 and FIG. 7. We propose to express the total conductivity σ_{T} as the weighted average of the individual conductivity contributions, as follows:

$${σ}_{T} ( T ) = {\sum }_{n = 1}^{5} {χ}_{n} {σ}_{n} \qquad ( 6 )$$

where the weight χₙ is the molar fraction of the σₙ contribution; σ_{T} approximates σ at a given temperature. The need to use this equation, as opposed to a simple arithmetic sum with weights all equal to 1, is imposed by the attempt to fully reconcile the results of the equivalent circuit analysis with those obtained from the analysis based on equation (5). While the arithmetic sum implies a perfect application of the superposition principle, equation (6) points to existence of some heterogeneity of the samples in the conductivity measurement, as explained below.

The first event (n=1) is attributed to the interdomain polarization phenomenon between nanodomains comprised of PEG-PFPE-PEG-based electrolytes with NaTFSI as dopant and nanodomains including PEG-PFPE-PEG, NaTFSI, and a small percentage of DMSO. A solid polymer electrolyte was prepared based on PEG-PFPE-PEG and NaTFSI. The resulting electrolytic complexes had very low conductivity that could not be measured directly, because the bulk resistance exceeded instrumental limits. Despite that, σ₁ could be extracted from the impedance data through the fitting process. These are the ranges of σ₁ in S·cm⁻¹ found for the different samples with increasing temperature from 10 to 80° C.: S1 5.0×10⁻⁹ to 2.0×10⁻⁷; S2 5.0×10⁻⁹ to 3.0×10⁻⁷; S3 3.0×10⁻⁸ to 3.0×10⁻⁷; S4 5.0×10⁻⁹ to 6.0×10⁻⁷; S5 5.0×10⁻⁹ to 2.0×10⁻⁷; S6 5.0×10⁻⁹ to 1.2×10⁻⁶; S7 5.0×10⁻⁸ to 4.0×10⁻⁷; S8 2.2×10⁻⁶ to 3.7×10⁻⁶. The range of these quite low conductivity values seems to systematically shift higher for decreasing salt concentration. This observation can be accounted for by realizing that, in the absence of DMSO or in the presence of a limited amount of DMSO, NaTFSI acts as a very effective reticulant toward the polymer host. The higher the salt concentration, the higher the reticulation effect. In other words, the coordination complexes formed between the salt and PEG-PFPE-PEG are very stable and do not enable effective long-range ionic migration. There is significant uncertainty about where the σ₁ plateau precisely occurs on the frequency scale, but a satisfactory fitting is obtained with f₁ fixed at 3.7×10⁻⁴ Hz.

The fifth event (n=5) is assigned to the electrode polarization phenomenon associated with nanodomains constituted by DMSO dissolving NaTFSI interfaced with the Pt electrodes. These are the fixed values of σ₅ in S·cm⁻¹ found for the different samples from 10 to 80° C.: S1 9.9×10⁻³; S2 1.7×10⁻¹; S3 7.5×10⁻²; S4 1.7×10⁻¹; S5 9.0×10⁻²; S6 1.5×10⁻¹; S7 8.5×10⁻²; S8 3.0×10⁻¹. The conductivity σ₅ is quite high, roughly constant, and typical of a liquid electrolyte system. The frequency f₅ takes on fixed values equal to 1.8×10⁷ Hz for S1 and 1.8×10⁸ Hz for S2 to S8. Based on equation (6), it can be deduced that this contribution must have a relatively small weight with respect to the first four. This ought to be the case since the bulk conductivity determined using the equivalent circuit is on the order of 10⁻⁴ to 10⁻³ S·cm⁻¹. It is likely that this contribution reflects the presence of some liquid DMSO/NaTFSI on the surface of the Pt electrodes. It is likely that these nanodomains represent small liquid leakages from the plasticized PEs onto the surface of the blocking electrodes. This would account for the need to use equation (6) and implies that the electrical measurements, through the conductivity cell, detect a small measure of heterogeneity in the samples. This explanation can be validated in a different way. Equation (6) can be used to determine algorithmically (using Microsoft Data Solver) for what values of the weights Xₙ the equivalent circuit conductivity σ, at a given temperature, can be simulated based on the five values of σₙ. Imposing equal weights (Xₙ=0.2) as an initial condition, the typical set of Xₙ converges to values nearly equal and less than 0.25, while the fifth value is less than 1.5% of such values. This finding indicates again that the fifth contribution is due to a small heterogeneity and that the arithmetic sum would work instead of equation (6) if the samples were perfectly homogeneous.

The central polarization events (n=2, 3, 4) are fully contained in the frequency interval of the electrical measurements (FIG. 6 and FIG. 7). Three is the minimum number of events necessary to successfully complete the fitting. Indeed, individual peaks are glimpsed in the profiles of σ″(ω). It cannot be excluded that these three peaks capture the essential features of a continuous distribution. These events are attributed to interdomain polarizations between nanodomains in the PEs with increasing amounts of DMSO. For the sake of argument and visualization, we can hypothesize that there are five nanodomains containing 0%, 20%, 50%, 70%, and 100% of DMSO. A direct nanoscopic technique with analytical capabilities would be necessary to measure the percentages of these nanodomains directly. The interdomain interfaces would be the following: 0%-20%, 20%-50%, 50%-70%, and 70%-100%. The electrode interface would be 100%-Pt. Regardless of the accurate percentages, the nanodomains may be more or less physically connected with other nanodomains of the same kind or different kind. The connectivity will depend on the relative abundance of the nanodomains, their size, and their distribution. The resulting homo- or heterodomain sublattices will provide paths for the percolation of the ions. The segmental motion of the polymer chains is likely to produce mesoscopic oscillatory changes in shape and volume of the liquid domains, leading to what we could define as a “peristaltic” ion-conduction mechanism. A similar type of mechanism was discovered in composite proton-conducting materials. Here, the term peristaltic refers to an alternating squeeze exerted on the liquid domains, caused by the applied oscillating electric field. The sublattices should not be imagined as static but rather as participating in a temperature-dependent equilibrium dynamics by continuously breaking and forming interdomain connections.

The conductivities σ₂, σ₃, and σ₄ vs reciprocal temperature are satisfactorily fitted by the VTF Equation (1). The fitting of the frequencies f₂, f₃, and f₄ vs reciprocal temperature can be performed using one or two added Arrhenius equations of this type:

$${f}_{n} ( T ) = {A}_{{f}_{n}} ( \frac{- {E}_{a , {f}_{n}}}{RT} ) \qquad ( 7 )$$

where A_{f}_{ₙ} is a pre-exponential factor and E_{a,f}_{ₙ} is the activation energy related to the frequency shift of the nth event (n=2, 3, 4). The conductivity decreases in the following order σ₂>σ₃≈σ₄, except for sample S2, for which σ₂>σ₄>σ₃. The ionic charge carriers increase with salt concentration as follows: A_{σ}_{₃}>A_{σ}_{₂}>A_{σ}_{₄}. The pseudoactivation energies for individual domain conduction Ea,σdn present an overall increase in the following order E_{a,σ}_{₃}>E_{a,σ}_{₂}≈E_{a,σ}_{₄} in the interval 3-17 kJ/mol, similarly to E_{a,σ}. These results seem to indicate that interdomain interface 2 (20%-50%), out of the central interdomain interfaces (20%-50%, 50%-70%, and 70%-100%), represents the most common nodal connection interface giving rise to the most effective sublattice for long-range ion transport. In sample S2, interdomain interface 2 (20%-50%) remains dominant but interdomain interface 4 (70%-100%) becomes more important than interdomain interface 3 (50%-70%). This observation indicates that a more DMSO-rich interface (70%-100%), fosters a higher liquid-like ionic migration and becomes more relevant to the overall conductivity. Indeed, sample S2 exhibits the highest room temperature conductivity.

The frequencies decrease in the following order: f₄>f₃>f₂. The profiles of A_{f}_{ₙ} indicate that with increasing salt concentration, A_{f}_{₃}≈A_{f}_{₄}>A_{f}_{₂}. Similarly, for E_{a,f}_{ᵢ}, it is observed that E_{a,f}_{₃}≈E_{a,f}_{₄}>E_{a,f}_{₂}. Regions I and II here refer to the lower temperatures and higher temperatures, respectively. When there is a splitting of the parameters, due to the use of two Arrhenius equations, both A_{f}_{ₙ} and E_{a,f}_{ₙ} are found to be bigger in region II than in region I. Overall, the VTF-dependence of σ₂, σ₃, and σ₄ vs 1/T indicates that the segmental motion of the polymer host and DMSO micro-Brownian motions assist the ion-conduction process. At the same time, the Arrhenius dependence of f₂, f₃ and f₄ vs 1/T suggests that liquid DMSO confers a liquid-like behavior to ionic conduction in the PEs. Ionic hopping is likely to occurs within the DMSO domains and between domains. The segmental motion of the polymer host modulates, in a peristaltic manner, the efficiencies of the DMSO-rich domain sublattices in providing a pathway for long-range ionic migration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A polymer electrolyte comprising:
a block polymer formed from the block copolymerization of a polyethylene glycol (PEG) and a perfluorinated polyether (PFPE);
an electrolyte-plasticizer composition comprising (NaTFSI)ₓ(DMSO)_{y}, wherein
DMSO is dimethylsulfoxide;
NaTFSI is bis(trifluoromethane)sulfonimide sodium salt;
x is mole percent of the NaTFSI relative to moles of the block polymer, 0.004≤x≤0.610;
y is mole percent of the DMSO relative to moles of the block polymer, 3.205≤y≤3.794;
wherein
the block polymer is present in a mass percent of 70±10;
the DMSO is present in a mass percent of 20±5; and
the NaTFSI is present in a mass percent from 0.09-13%.

2. The polymer electrolyte as recited in claim 1, wherein the DMSO is present in a mass percent of 20±2.

3. The polymer electrolyte as recited in claim 1, wherein the block polymer is present in a mass percent of 73±8.

4. The polymer electrolyte as recited in claim 1, wherein the block polymer is present in a mass percent of 75±5.

5. The polymer electrolyte as recited in claim 1, wherein the NaTFSI is present in a mass percent from 0.09-7%.

6. The polymer electrolyte as recited in claim 1, wherein the NaTFSI is present in a mass percent from 0.09-4%.

7. The polymer electrolyte as recited in claim 1, wherein the NaTFSI is present in a mass percent from 0.09-2%.

8. The polymer electrolyte as recited in claim 1, wherein the NaTFSI is present in a mass percent from 0.09-1%.

9. A polymer electrolyte comprising:
a block polymer formed from the block copolymerization of a polyethylene glycol (PEG) and a perfluorinated polyether (PFPE);
an electrolyte-plasticizer composition comprising (NaTFSI)ₓ(DMSO)_{y}, wherein
DMSO is dimethylsulfoxide;
NaTFSI is bis(trifluoromethane)sulfonimide sodium salt;
x is mole percent of the NaTFSI relative to moles of the block polymer, 0.004≤x≤0.610;
y is mole percent of the DMSO relative to moles of the block polymer, 3.205≤y≤3.794;
wherein
the block polymer is present in a mass percent of 73±8;
the DMSO is present in a mass percent of 20±2; and
the NaTFSI is present in a mass percent from 0.09-13%.

10. The polymer electrolyte as recited in claim 9, wherein the block polymer is present in a mass percent of 75±5.

11. The polymer electrolyte as recited in claim 9, wherein the NaTFSI is present in a mass percent from 0.09-7%.

12. The polymer electrolyte as recited in claim 9, wherein the NaTFSI is present in a mass percent from 0.09-4%.

13. The polymer electrolyte as recited in claim 9, wherein the NaTFSI is present in a mass percent from 0.09-2%.

14. The polymer electrolyte as recited in claim 9, wherein the NaTFSI is present in a mass percent from 0.09-1%.
